(19) United States
(12) Patent Application Publication
(10) Pub. No.: US 2026/0238988 A1
(43) Pub. Date: Aug. 13, 2026

(54) Method and Apparatus for Enhanced Beam Reporting and Unified TCI Indication for Simultaneous Transmission Over Multiple Panels (STXMP) in Wireless Communication

(71) Applicant: Apple Inc., Cupertino, CA (US)

(72) Inventors: Hong He, San Jose, CA (US); Dawei Zhang, Saratoga, CA (US); Haitong Sun, Saratoga, CA (US); Jie Cui, San Jose, CA (US); Dan Wu, Beijing (CN); Wei Zeng, Saratoga, CA (US); Weidong Yang, San Diego, CA (US); Oghenekome Oteri, San Diego, CA (US); Chunxuan Ye, San Diego, CA (US); Huaning Niu, San Jose, CA (US)

(21) Appl. No.: 19/154,699

(22) PCT Filed: Feb. 10, 2023
(86) PCT No.: PCT/CN2023/075387

§ 371 Date: Aug. 7, 2025

(51) Int. Cl. H04W 8/22; H04B 7/06; H04W 56/00; H04W 72/231; H04W 76/20

(52) U.S. Cl. CPC H04W 8/22; H04B 7/0626; H04W 56/0015; H04W 72/231; H04W 76/20

(57) ABSTRACT

Method and Apparatus for Enhanced Beam Reporting and Unified TCI Indication for Simultaneous Transmission over Multiple Panels is disclosed. The current Unified TCI framework is expanded to include multi-TRPs and STxMP operations. Simultaneous multi-panel UL transmission for higher UL throughput/reliability focusing on multiple Transmission/Reception Point (mTRP) is provided. UL precoding indications for PUSCH transmission that do not require a new codebook for multi-panel simultaneous transmission are shown. TCI States for SRS resource sets to enable STxMP operation are established. Group Beam Reporting (GBR) for simultaneous UL multi-panel transmission (STxMP) operation, single DCI based STxMP transmission of a PUSCH, and multi-DCI based STxMP transmission of a PUCCH is disclosed.

### FIELD

The present application relates to wireless devices and wireless networks, including devices, circuits, and methods for managing simultaneous transmission over multiple panels.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

After the initial deployment of NR, the TCI state framework was unnecessarily flexible, which lead to significant signaling overhead. Later, a unified TCI framework was introduced (Release 17) that facilitates streamlined multi-beam operation in Frequency Range 2 (FR2) for a single Transmission/Reception Point (sTRP) communication. Further extension of unified TCI framework that focuses on multi-TRP use cases would be beneficial.

### SUMMARY

In one aspect, embodiments are related to a method of group beam reporting (GBR) for simultaneous uplink (UL) transmissions over Multiple Panels (STxMP) operation that includes a User Equipment (UE) reporting to a network in a UE capability report, an indexed STxMP capability list. In the list, each index indicates a maximum rank per panel for each panel of the UE. The method includes the UE receiving, by Radio Resource Control (RRC) signaling, instructions for GBR and an indication of a number of pairs of resources for reporting channel quality. The UE performs channel quality measurements on each of two CSI resource sets and selects one resource from each of the two CSI resource sets based on the channel quality measurements for the respective CSI resource set to form each pair of the number of pairs of resources. Each resource of a pair of resources of the number of pairs of resources can be used to determine a spatial relation for the STxMP UL transmissions. The method further includes transmitting a channel quality measurement report that includes the channel quality measurements of the pairs of resources and an index from the indexed STxMP capability list for each of the number of pairs of resources.

In another aspect, embodiments are related to a method of GBR for simultaneous UL STxMP operation that includes a UE reporting to a network in a UE capability report, an indexed STxMP capability list. Each index in the list indicates a maximum rank per panel for each panel of the UE. The method includes the UE receiving, by Radio Resource Control (RRC) signaling, instructions for GBR and an indication of a number of pairs of resources for reporting channel quality. The UE performs channel quality measurements on each of two CSI resource sets and selects one resource from each of the two CSI resource sets based on the channel quality measurements for the respective CSI resource set to form each pair of the number of pairs of resources. Each resource of a pair of resources of the number of pairs of resources may be used to determine a spatial relation for the STxMP UL transmissions. The method further includes transmitting a channel quality measurement report that includes the channel quality measurements of the pairs of resources and a logic panel identification for each resource of the number of pairs of resources.

In another aspect, embodiments relate to a method for multiple Downlink Control Information (mDCI) based STxMP Physical Uplink Shared Channel (PUSCH) transmission that includes the network determining multiple Sounding Reference Signals (SRS) resource sets for mDCI based STxMP PUSCH transmission. Each SRS resource set is associated with a panel of a UE and a Transmission/Reception Point (TRP). The method includes assigning each SRS resource set to a CORESET pool index and assigning a joint UL Transmission Configuration Indicator (TCI) state specific to the CORESET pool index to the SRS resource set of the same CORESET pool index. The network performs a channel quality estimation for an UL on at least one of the multiple SRS resource sets.

In another aspect, embodiments relate to a method for single Downlink Control Information (sDCI) based STxMP Physical Uplink Control Channel (PUCCH) transmission over multiple panels that includes receiving, by RRC signaling, a first indication that repetitious PUCCH transmission is not enabled, and determining that a second indication indicates that multiple resources are available for UL transmission of the PUCCH. The method further includes transmitting the PUCCH from each of at least two panels using the multiple resources.

The techniques described herein may be implemented in and/or used with a number of different types of devices, including but not limited to cellular phones, wireless devices, tablet computers, wearable computing devices, portable media players, Consumer Premises Equipment (CPE), Fixed Wireless Access (FWA), vehicles, industrial devices and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a BS, according to some aspects.

FIG. 5 illustrates an example system, in accordance with some aspects.

FIG. 6A illustrates an example of a 1-bit reporting IE definition in accordance with some aspects.

FIG. 6B illustrates an example of a 2-bit reporting IE definition in accordance with some aspects.

FIG. 6C illustrates part of an example GBR CSI report, in accordance with some aspects.

FIGS. 6D-6E illustrate an example using an STxMP index, in accordance with some aspects.

FIG. 7 illustrates s specific example system, according to some aspects.

FIGS. 8A and 8B provide two examples of GBR reports in a single CSI report instance, according to some aspects.

FIG. 9 is a flowchart illustrating methods for GBR, according to some aspects.

FIG. 10 is a flowchart illustrating methods for multiple Downlink Control Information (mDCI) based STxMP Physical Uplink Shared Channel (PUSCH) transmission, according to some aspects.

FIG. 11 is a flowchart illustrating methods for single-DCI (sDCI) based STxMP Physical Uplink Control Channel (PUCCH) transmission over multiple panels, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The evolution of the 5G and New Radio (NR) standards continuously improve network efficiency and energy savings for user equipment (UE) devices and base station (BS) devices. Further improvements are needed in terms of both transmission and reception procedures, and especially to multi-panel transmission and reception procedures.

Embodiments disclosed herein expand upon the current (Release 17) Unified TCI framework to include multi-TRPs and STxMP operations. Embodiments include indications of multiple DL and UL TCI states focusing on multi-TRP use case. Embodiments are also directed to simultaneous multi-panel UL transmissions for higher UL throughput/reliability, focusing on FR2 and multi-TRP operation. In the examples herein, up to 2 TRPs and up to 2 panels are demonstrated. However, one of ordinary skill in the art will appreciate that devices are not limited to only two panels. For example, in this context, a UE may include Consumer Premises Equipment (CPE), Fixed Wireless Access (FWA), vehicles, and industrial devices that may have any number of panels.

Embodiments disclosed herein include an UL precoding indication for PUSCH transmission. The UL precoding for PUSCH may not require a new codebook for multi-panel simultaneous transmission. Embodiments disclosed herein consider both single DCI and multi-DCI based multi-TRP operation.

For STxMP transmission, the UE must establish that it can transmit two signals simultaneously, or under what circumstances the UE may transmit two signals simultaneously. For example, the STxMP may not always be possible, due to UE position, rotation, and/or mobility. In order to schedule a PUSCH using STxMP, the network must be made aware if the UE can communicate with the target TRPs using both panels.

Although the association between the PUSCH and indicated TCI State for PUSCH transmission in case of mDCI mTRP has been established (including both DG-PUSCH and Type-2 CG-PUSCH), TCI States for SRS resource sets to enable STxMP operation are not established. Embodiments disclosed herein determine and associate TCI States for SRS resource sets to enable STxMP operation. Embodiments further associate the TCI states for STxMP transmission of a PUCCH.

More specifically, embodiments describe Group Beam Reporting (GBR) for simultaneous UL transmission over multiple panels (STxMP) operation. Embodiments further describe single DCI based STxMP transmission of a PUSCH, and multi-DCI based STxMP transmission of a PUCCH.

The following is a glossary of terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-Attorney up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB.’ If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

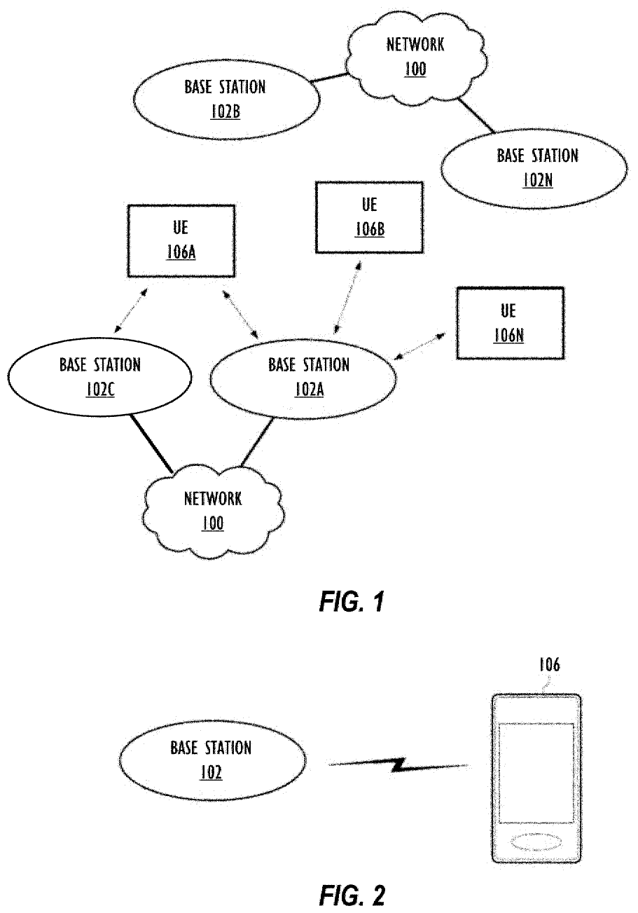

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocols discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

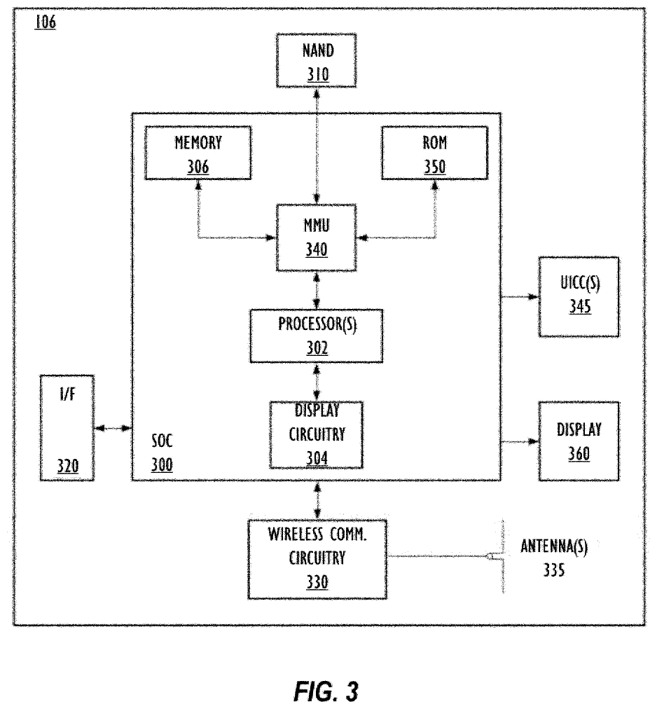

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

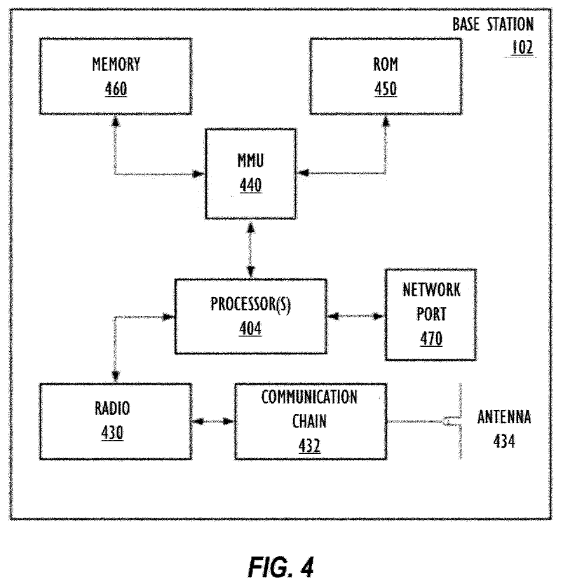

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

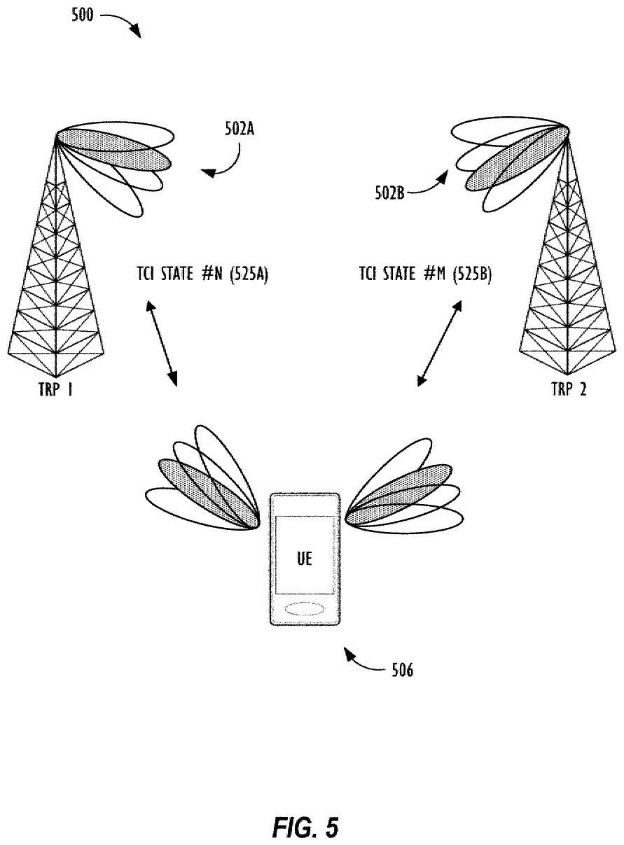

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

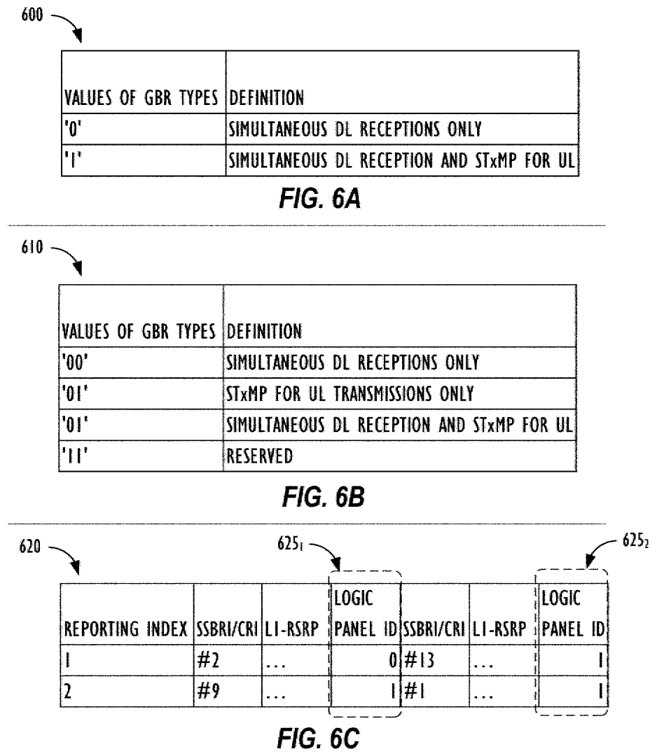

FIG. 5 illustrates an example simplified system, according to some aspects. The system 500 illustrates mTRP communication between TRP 1 502A and a UE 506 and TRP 2 502B and the UE 506. The UE 506 is illustrated with a panel on each side, each panel with one or more transceivers capable of BM in accordance with current beamforming and MIMO techniques. In accordance with such techniques and embodiments herein, TRP 1 502A may communicate with the UE 506 via TCI State #N 525A, and TRP 2 502B may communicate with the UE 506 via TCI State #M 525B. In this context, the labels ‘M’ and ‘N’ refer to integer values used to identify a specific TCI state. Such TCI States may be associated with a lobe in the BM organization. For example, the shaded lobe in FIG. 5 may be associated with a TCI state and TRP in accordance with embodiments disclosed herein.

In accordance with this disclosure, a variety of approaches are presented to enable beam reporting for STxMP operation. In embodiments disclosed herein, a Group-based reporting mode is introduced for UL STxMP Operation.

In some embodiments, a UE reports a number of groups ‘N’ of two CSI-Attorney RS Resource Indexes (CRIs) or SSB Resource Indexes (SSBRIs) in a reporting instance. In such embodiments, one CSI-RS or SSB from a CSI Resource Set is selected for reporting. In embodiments disclosed herein, the CSI-RS and/or SSB resources of each group may be used to determine two different spatial relations for STxMP UL transmissions on two panels.

The number of groups ‘N’ may be explicitly configured by RRC signaling, which is subject to UE capability report. That is, the UE may establish a maximum number of groups acceptable in a UE capability report. The network may then configure the number of groups ‘N’ for a reporting instance in an RRC message to the UE.

Embodiments disclosed herein include techniques to differentiate the UL group-based Beam reporting from DL group-based Beam reporting. In some embodiments, differentiating the UL from the DL may be expanded from existing (Release 17) BM techniques.

In some embodiments, different CSI report configurations and configuration IDs are provided for UL Group-based Beam Reporting (GBR) and DL group-based Beam reporting. For example, an indicator may be included to indicate either UL or DL GBR. A 1-bit reporting type IE included in the CSI report setting could be used to indicate either UL GBR or DL GBR. For instance, the value ‘0’ may be used to indicate the ‘DL’ GBR and the value ‘1’ may be used to indicate the UL GBR for STxMP operation. In such embodiments, a single CSI report instance may be limited to either DL or UL group reporting.

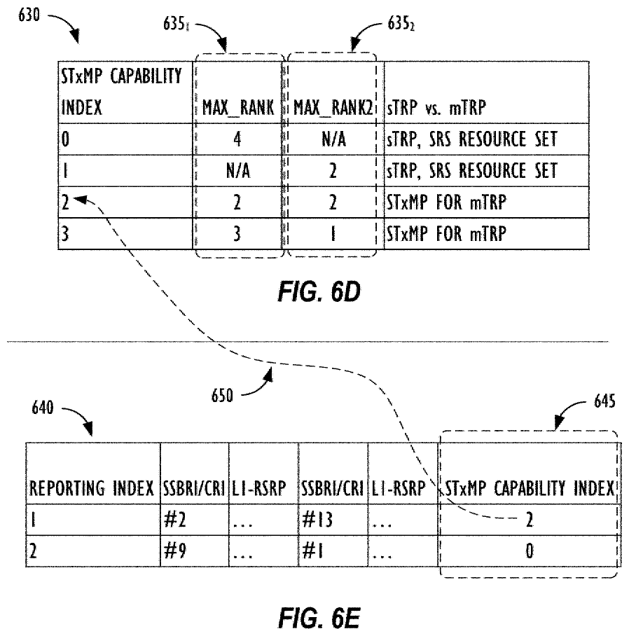

FIG. 6A illustrates another example 600 of a 1-bit reporting IE definition in accordance with some aspects. FIG. 6A defines the indicator IE that may be added to indicate UL/DL aspects for each group of CRIs or SSBRIs in a CSI report in GBR. In the example of FIG. 6A, the indicator IE ‘0’ indicates simultaneous DL receptions only, while the indicator IE ‘1’ indicates both simultaneous DL receptions and STxMP for UL reception.

In some embodiments, one CSI report may be used for both DL GBR and UL GBR. In such embodiments, an indicator may be added into the CSI report setting to indicate the UL/DL aspects. For example, a 2-bit reporting type IE may be added into CSI report setting to indicate the UL/DL aspects. The IE may represent the candidate values: UL GBR only, DL GBR only, both DL GBR and UL GBR. In such embodiments, the order of the DL GBR and the UL GBR in the CSI report may be hard encoded. For example, the CSI report may provide the DL first and UL second, or vice versa. That is, the UL/DL order presented in a CSI report may be configured as part of CSI reporting methods in accordance with embodiments disclosed herein.

FIG. 6B illustrates another example 610 an indicator IE to indicate simultaneous UL/DL aspects for each group of CRIs or SSBRIs in a CSI report in GBR, according to some aspects. In the example 610 of FIG. 6B the 2-bit indicator ‘00’ indicates simultaneous DL receptions only; indicator ‘01’ indicates STxMP for UL transmissions only; indicator ‘10’ indicates simultaneous DL receptions and STxMP for UL reception. The indicator ‘11’ may be reserved for future considerations. In some embodiments, when GBR is used for STxMP operation in accordance with FIG. 6B, a UE may additionally report a corresponding UL ‘layerCombination’ index or ‘SRS ports combination’ index in a UE capability report.

Compared to embodiments of FIG. 6A, the embodiments of FIG. 6B may reduce signaling overhead by sharing the reported SSBRI/CRIs and L1-RSRP between DL GBR and UL GBR for a subset of reported beams in a same report instance.

FIG. 6C illustrates part of an example GBR CSI report, in accordance with some aspects. FIG. 6C illustrates an example where the UE reports a Panel ID or Panel-dedicated logic ID for each SSB or CSI-RS reported in a GBR. Specifically, the GBR CSI report includes a logic panel ID 625₁, 625₂ for each measurement in the report.

In the example, each reporting index provided in the report includes a pair of measurements. Each measurement includes an index identifying the specific SSBRI/CRI, and the results of the measurement L1-RSRP, and the logical panel ID. The index identifying the specific SSBRI/CRI may be established in accordance with the TCI framework introduced in FIG. 5. The logic panel ID may be used by the network to identify whether the corresponding UL Beams are linked to a same panel or different panels. That is, by comparing the value of the logic panel ID 625₁ to the logic panel ID 625₂ in a single reporting index, the network may determine if the measurements are linked to the same or different panels.

In accordance with some embodiments disclosed herein, to facilitate STxMP operation, a list of UL capabilities maybe reported for each Panel of STxMP Operation for the UE. A capability report of the UE may include a list of ‘max ranks’ (layers) or ‘maximum number of SRS ports’ combinations representing the UE's capabilities in this context. In embodiments disclosed herein, the total number of layers may be up to four across all panels, and the total number of codewords may be up to two across all panels. The reported UE capabilities may be common across all UL BWPs/CCs in the same band (e.g., due to a shared RF antenna panel) or Band Combination.

FIG. 6D shows an example of UE capabilities structure for STxMP operation, according to some aspects. In accordance with some embodiments, one exemplified ASN.1 Code may be provided to implement the STxMP UE capability report. The example capabilities list of FIG. 6D includes UE capabilities for STxMP operation with two panels. Two values of a given STxMP capability are provided for each of the panels, maxRank and maxRank2. The maxRank 635₁ is associated with a first panel, while maxRank2 635₂ is associated with a second panel. The maxRank indicates the maximum number of layers supported for the PUSCH associated with an SRS resource set. The number of layers may be the same (e.g., STxMP capability index ‘2’) or different (e.g., STxMP capability index ‘3’). FIG. 6 also includes information regarding sTRP capabilities. In some embodiments, the STxMP capability index may be expanded to further include the maxRank for sTRP operation. Such embodiments may facilitate the expansion to mTRP from sTRP operations, while helping to maintain network efficiency.

In the example of FIG. 6D, the UE capabilities include both sTRP (single panel) characteristics and mTRP characteristics. However, embodiments are not limited as such. In some embodiments, the UE capabilities may only include the information necessary for STxMP and mTRP. In such embodiments, the STxMP capability index would only be defined for the last two entries shown in FIG. 6D.

FIG. 6E illustrates a GBR report, according to some aspects. As illustrated, the GBR report includes an STxMP capability index 645 for each pair of reported SSBRI/CRIS. As indicated by the arrow 650, the STxMP capability index associates the maxRanks of the panels to the reported measurement.

FIG. 6D includes both single panel capabilities (e.g., indexes 0,1) and multi-panel capabilities for STxMP operation. A corresponding GBR report may appropriately include single panel measurements in accordance with some embodiments.

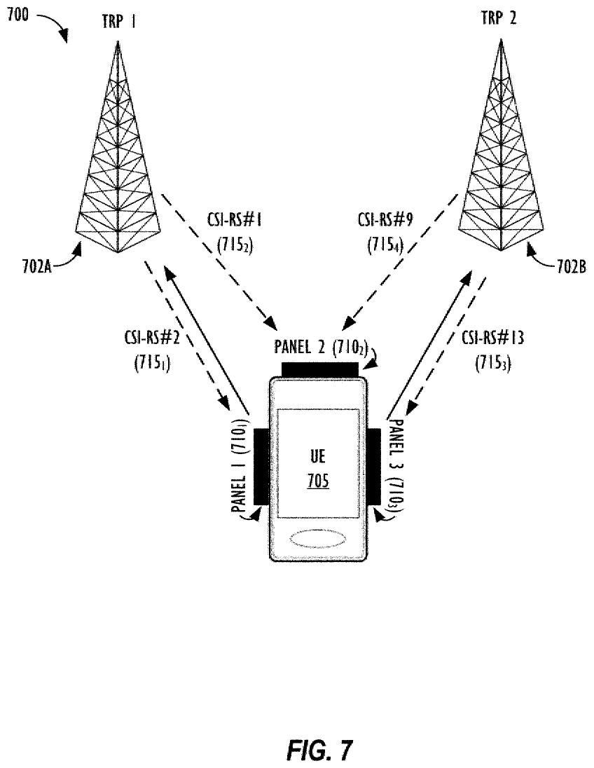

FIG. 7 illustrates a specific example system, according to some aspects. In the system 700 of FIG. 7, three antenna panels 710₁, 710₂, and 710₃ are included on the UE 705. A mTRP operation involving two TRPs (TRP #1 702A and TRP #2 702B) are configured to communicate with the UE 705. The solid lines indicate the UL, while the dashed lines indicate the DL. FIG. 7 further demonstrates CSI-RS indexes 715₁ to 715₄ to illustrate the communication between the UE 705 and TRPs 702A, 702B.

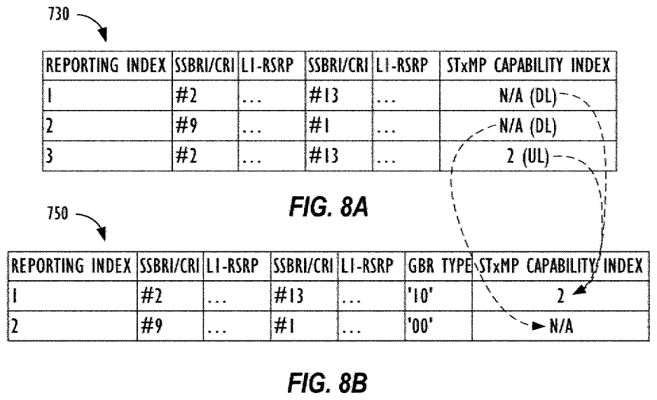

In accordance with some embodiments, the UE may be configured for GBR in the DL, UL, or in both the UL and the DL. For example, as demonstrated in FIGS. 8A and 8B, embodiments may use the CSI report setting to instruct the UE to report 2 DL GBRs and 1 UL GBR in a single CSI report instance. In such embodiments, the UE may report capabilities, include the STxMP capabilities, in accordance with FIG. 6D.

FIGS. 8A and 8B provide two examples of GBR reports in a single CSI report instance in accordance with FIG. 7, according to some aspects. As noted above, the UE has been instruction to report 2 DL GBRs and 1 UL GBR in a single CSI report instance in accordance with a CSI report setting. FIG. 8A demonstrates a GBR report 730 where the UE reports three entries, including separate 2 DL GBRs (index #1 and index #2) and 1 UL GBR (index #3) for STxMP operation. As shown, the 2 DL entries do not include an STxMP capability index, while the UL entry includes the STxMP capability index associated with the UE capabilities.

FIG. 8B illustrates another example of a GBR report in a single CSI report instance in accordance with FIG. 7. In FIG. 8B, the GBR report 750 reports only two entries in accordance with some embodiments. The GBR index #1 and index #3 shown in FIG. 8A are combined in FIG. 8B. That is, GBR index 1 of FIG. 8B refers to measurements of CSI-RS #2 and CSI-RS #13 that are shared for DL simultaneous receptions and UL STxMP transmissions on Panel #1 and Panel #3, respectively. FIG. 8B further includes a GBR type indicator. The GRB type indicator may refer to a definition in accordance with FIG. 6B, as shown in the example. Thus, the GBR type indicator is set to ‘10’ together with STxMP capability Index #2. Recall, the GBR type indicator ‘10’ defines simultaneous DL reception and STxMP for UL transmissions. In the example, the GBR type indicator of entry #2 is set to ‘00’ because only single panel #2 is involved in this measurement, and this panel may not be capable of STxMP operation.

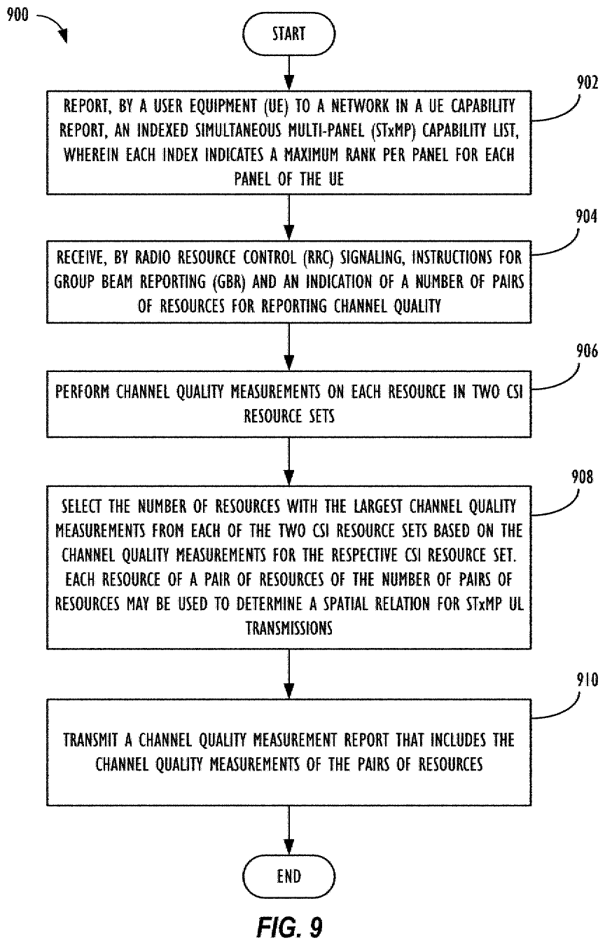

FIGS. 9-11 provide various methods in accordance with the aspects described above.

FIG. 9 is a flowchart illustrating methods for GBR, according to some aspects. In the method 900, the UE reports to the network an indexed simultaneous transmission over multiple panels (STxMP) capability list in a UE capability report in block 902. Each index indicates a maximum rank per panel for each panel of the UE. For example, FIG. 6D illustrates one embodiment of a definition of such capabilities. In accordance with embodiment disclosed herein, the indexed capability may indicate the maximum number of layers, the maximum number of ranks (maxRank), or maximum number of Sounding Reference Signal (SRS) ports when an uplink signal is transmitted using a single panel.

In block 904, the UE receives instructions for GBR and an indication of a number of pairs of resources for reporting the channel quality in an RRC message. The resources may include CSI-RS or SSBRI.

The US performs channel quality measurements on each resource in two CSI resource sets to be used by the UE in block 906. In block 908, the number of resources with the largest channel quality measurement is selected from each of the two CSI resource sets based on the channel quality measurements for the respective CSI resource set. Each resource of a pair of resources of the number of pairs of resources may be used to determine a spatial relation for STxMP UL transmissions.

In block 910, a channel quality measurement report is transmitted that includes the channel quality measurements of the pairs of resources. In some embodiments, the channel quality measurement report may further include an index from the indexed STxMP capability list for each of the numbers of pairs of resources. In some embodiments, the channel quality measurement report may further include a logic panel identification for each resource of the number of pairs of resources.

The quality measurement report may also include an indicator of downlink, uplink, or both downlink and uplink reporting according to some embodiments. In some embodiments, the instructions to perform GBR may include an indication of resources to use for reporting channel quality in the uplink and the downlink.

According to some embodiments, two SRS resource sets maybe configured for mDCI based STxMP PUSCH transmission, where each SRS resource set is used for a single panel. The SRS resource set may be linked to a particular panel towards a TRP implicitly or via RRC signaling.

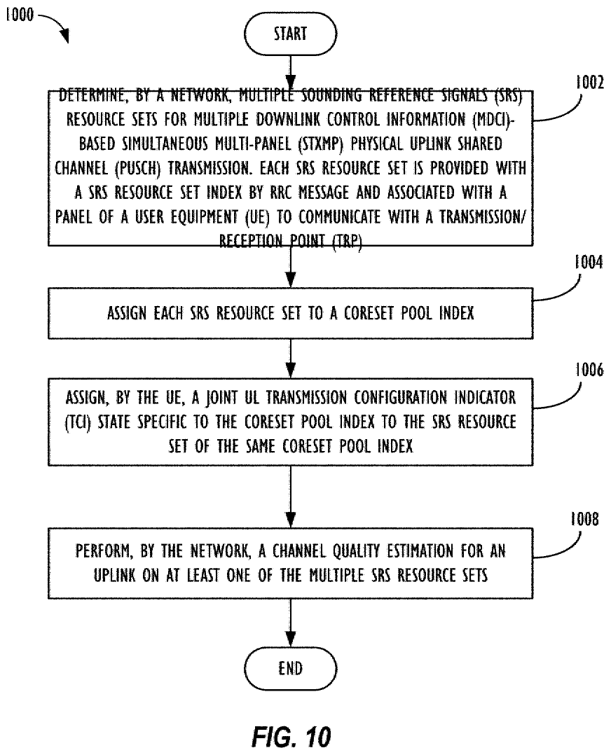

FIG. 10 is a flowchart illustrating methods for mDCI based STxMP PUSCH transmission, according to some aspects. In the method 1000 of FIG. 10, the network determines multiple SRS resource sets for mDCI based STxMP PUSCH transmission in block 1002. Each SRS resource set is provided with a SRS resource set index by RRC message and associated with a panel of a UE to communicate with a TRP.

In block 1004, each SRS resource set is assigned to a CORESET pool index. In some embodiments, the SRS resource set with a lower ID is implicitly associated with coresetPoolIndex value 0. In other embodiments, a coresetPoolIndex value may be configured for each SRS Resource Set by RRC signaling. In such embodiments, to reduce signaling overhead, a default value (e.g., coresetPoolIndex value ‘0’) maybe assumed for an SRS resource set if an indicator of a ‘coresetPoolIndex’ is not present. In some embodiments, the SRS resource set with a lower ID is implicitly associated with coresetPoolIndex value 0 if there is no explicit configuration provided by RRC signaling.

In block 1006, the UE assigns a joint UL TCI state specific to the CORESET pool index to the SRS resource set of the same CORESET pool index. Such embodiments may be used to determine UL TCI state for SRS Resource Sets transmissions with a unified TCI framework extension for mDCI based mTRP communication. The network then performs a channel quality estimation for an uplink on at least one of the multiple SRS resource sets in block 1008.

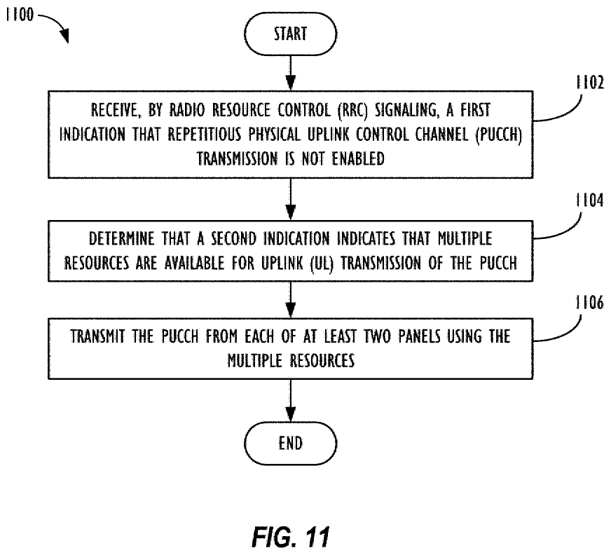

According to some embodiments, STxMP operation of ‘PUCCH+PUCCH’ transmission over two panels may be enabled for sDCI-based mTRP. FIG. 11 is a flowchart illustrating methods for single-DCI (sDCI) based STxMP Physical Uplink Control Channel (PUCCH) transmission over multiple panels, according to some aspects.

‘PUCCH+PUCCH’ transmission over two panels may be enabled for sDCI-based mTRP provided repetitions of a PUCCH transmission are not enabled for a PUCCH resource by the RRC parameter ‘nrofSlots’ or ‘pucch-RepetitionNrofSlots’. Accordingly, in block 1102, the UE receives by RRC signaling, an indication that repetitious PUCCH transmission is not enabled.

Further, ‘PUCCH+PUCCH’ transmission over two panels may be enabled for sDCI-based mTRP provided both of the two indicated joint or UL TCI states for the PUCCH resource are available. Such embodiments may include an indicator that indications ‘both’ resources are available for transmission of the PUCCH. Accordingly, in block 1104, a determination that a second indication indicates that multiple resources are available for UL transmission of the PUCCH.

If the above conditions are met, the two indicated TCI states provided by RRC signaling may be applied to the PUCCH resource or a group of PUCCH resources. The PUCCH is transmitted from each of at least two panels using the multiple resources in block 1106.

Embodiments disclosed herein expand upon the current (Release 17) Unified TCI framework to include multi-TRPs and STxMP operations. Embodiments provide simultaneous multi-panel UL transmission for higher UL throughput/reliability, focusing on FR2 and multi-TRP operation.

Embodiments disclosed herein include an UL precoding indication for PUSCH transmission that advantageously may not require a new codebook for STxMP. Embodiments disclosed herein consider both single DCI and multi-DCI based multi-TRP operation.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of group beam reporting (GBR) for simultaneous uplink (UL) transmissions over Multiple Panels (STxMP) operation, the method comprising:
reporting, by a User Equipment (UE) to a network in a UE capability report, an indexed STxMP capability list, wherein each index indicates a maximum rank per panel for each panel of the UE;
receiving, by Radio Resource Control (RRC) signaling, instructions for GBR and an indication of a number of pairs of resources for reporting channel quality;
performing channel quality measurements on each resource in two CSI resource sets received by the UE by RRC signaling;
selecting a number of resources with the largest channel quality measurements from each of the two CSI resource sets based on the channel quality measurements for the respective CSI resource set to form the number of pairs of resources, wherein each resource of a pair of resources of the number of pairs of resources can be used to determine a spatial relation for the STxMP UL transmissions; and
transmitting a channel quality measurement report that comprises the channel quality measurements of the pairs of resources and an index from the indexed STxMP capability list for each of the number of pairs of resources.

2. The method of claim 1, wherein the RRC configuration of a quality measurement report comprises an information element (IE) that indicates the quality measurement report is either a downlink or an uplink GBR reporting.

3. The method of claim 1, the RRC configuration of the quality measurement report comprises an information element (IE) that indicates the quality measurement report is to include either downlink GBR reporting only, or a uplink GBR reporting only, or both downlink and uplink GBR reporting.

4. The method of claim 1, wherein the indexed STxMP capability list further comprises an indexed capability related to single panel uplink transmissions towards a single Transmission/Reception Point (TRP), wherein the indexed capability indicates either the maximum number of layers, maximum ranks, or maximum number of Sounding Reference Signal (SRS) ports when an uplink signal is transmitted using a single panel.

5. The method of claim 1, wherein each resource comprises a CSI-RS resource and identified by a value of CSI-RS Resource Index (CRI).

6. The method of claim 1, wherein each resource comprises an SSB resource and identified by a value of SSB Resource Index (SSBRI).

7. The method of claim 1, wherein the instructions to perform GBR comprise an indication of resources in two CSI resource sets to be used by the UE for channel measurement and reporting channel quality in the uplink GBR reporting and the downlink GBR reporting.

8. (canceled)

9. A method for multiple Downlink Control Information (mDCI) based Simultaneous transmission Physical Uplink Shared Channel (PUSCH) transmissions over Multi-Panels (STxMP), the method comprising:
determining, by the network, multiple Sounding Reference Signals (SRS) resource sets for mDCI based STxMP PUSCH transmission, wherein each SRS resource set is provided with a SRS resource set index by RRC message and associated with a panel of a User Equipment (UE) to communicate with a Transmission/Reception Point (TRP);
assigning a first SRS resource set to a first value of a CORESET pool index; and
assigning, by the UE, a joint UL Transmission Configuration Indicator (TCI) state specific to the first value of the CORESET pool index to the first SRS resource set;
performing, by the network, a channel quality estimation for an uplink on at least one of the multiple SRS resource sets.

10. The method of claim 9, wherein each SRS resource set is assigned to a value of a CORESET pool index in a Radio Resource Control (RRC) message received by the UE.

11. The method of claim 9, wherein the SRS resource set with the lowest index value is implicitly assigned to a value ‘0’ of CORESET pool index.

12. The method of claim 9, wherein, in the absence of an assignment of the SRS resource to a CORESET pool index in a Radio Resource Control (RRC) message, the SRS resource set with the lowest index value is implicitly assigned to a value ‘0’ of CORESET pool index.

13. A method for single Downlink Control Information (sDCI) based simultaneous Physical Uplink Control Channel (PUCCH) transmissions over multiple panels (STxMP), the method comprising:
receiving, by RRC signaling, a first indication that repetitious PUCCH transmission is not enabled;
determining that a second indication indicates that multiple resources are available for uplink (UL) transmissions of the PUCCH; and
transmitting the PUCCH from each of at least two panels using the multiple resources.

14. The method of claim 13, wherein each resource in multiple resources is a joint UL Transmission Configuration Indicator (TCI) state or joint unified TCI-state for both DL and UL communication.

15. The method of claim 14, wherein an indication of the resources is received by RRC signaling from the network.

16. The method of claim 13, wherein the second indication is received by RRC signaling by the network.

17. (canceled)

18. (canceled)

19. (canceled)
